(19) United States
(12) Patent Application Publication
(10) Pub. No.: US 2026/0242147 A1
(43) Pub. Date: Aug. 20, 2026

(54) SYSTEM AND METHOD FOR PROCESSING A MIXTURE OF MATERIALS

(71) Applicant: General Kinematics Corporation, Crystal Lake, IL (US)

(72) Inventor: Alan D. Grove, Wonder Lake, IL (US)

(21) Appl. No.: 19/540,203

(22) Filed: Feb. 13, 2026

Related U.S. Application Data
(60) Provisional application No. 63/758,841, filed on Feb. 14, 2025.

(51) Int. Cl. B65G 21/14; B07B 1/46

(52) U.S. Cl. CPC B65G 21/14; B07B 1/4618; B07B 1/4645

(57) ABSTRACT

A system for separating a mixture of materials includes a first recirculation loop including at least one separation station. The at least one separation station has an inlet configured to receive the mixture of materials and at least a first and a second outlet. The first outlet is coupled to the inlet via a shredder and the second outlet is coupled to at least one holding bunker. The system also includes a second recirculation loop including at least one separation station. The at least one separation station has an inlet coupled to the at least one holding bunker and at least a first and a second outlet. The first outlet is coupled to the at least one holding bunker and the second outlet is coupled to a discharge bunker. A method is also provided.

This patent claims the benefit of U.S. Provisional Patent App. No. 63/758,841, filed February 14, 2025, which application is expressly incorporated herein by reference in its entirety.

### BACKGROUND

This patent is directed to a system and method for processing a mixture of materials, such as may be generated during construction and/or demolition, and, in particular, to a system and method for processing such mixed materials wherein the system and method has at least two recirculating loops.

Construction and demolition waste generally includes a wide variety of materials, such as wood, concrete/brick/block, cardboard, ferrous and non-ferrous metals, plastic, drywall, glass, dirt/soil/fines, and shingles. Some of these materials are valuable for resale, if they can be separated from those materials that do not have value (e.g., dirt/soil/fines). Moreover, even those materials that have value may see their value vary over time. That is, the value of a particular material may be more at one time and less at another time.

Unfortunately, it is not always possible to remove the valuable materials easily from the other materials. Indeed, many systems used to process such materials from construction and demolition sites rely heavily on human labor to sort the materials to obtain the desired separation of materials. As such, the processing systems can experience lulls or delays in the processing as the workers complete their shifts, or require multiple shifts of workers to keep the processing relatively continuous.

Even those systems that rely more heavily on automation (as opposed to human workers) are not uniformly designed to change their processing according to changes in the value of the materials being separated, for example. That is, these systems are structurally and functionally optimized to separate a particular material from a mix of materials, but this limits their ability to separate a different material or set of materials from a mix of materials. Consequently, these systems present a different set of challenges.

It would be advantageous to overcome or substantially ameliorate one or more of the disadvantages of existing mixed material processing systems and methods with a system and method of novel and inventive design for processing a mixture of materials, such as construction and demolition waste materials, or at least to provide a useful alternative.

### SUMMARY

According to one aspect of the present disclosure, a system is provided for separating a mixture of materials. The system includes a first recirculation loop including at least one separation station. The at least one separation station has an inlet configured to receive the mixture of materials and at least a first and a second outlet. The first outlet is coupled to the inlet via a shredder and the second outlet is coupled to at least one holding bunker. The system also includes a second recirculation loop including at least one separation station. The at least one separation station has an inlet coupled to the at least one holding bunker and at least a first and a second outlet. The first outlet is coupled to the at least one holding bunker and the second outlet is coupled to a discharge bunker.

According to another aspect of the present disclosure, a method is provided for separating a mixture of materials. The method includes separating the mixture of materials into a first material stream and a second material stream, shredding and returning the first material stream for further separation, and directing the second material stream to at least one holding bunker. The method also includes separating materials from the at least one holding bunker into a third material stream and a fourth material stream, returning the third material stream to the at least one holding bunker, and directing the fourth material stream to at least one discharge bunker.

### BRIEF DESCRIPTION OF THE DRAWINGS

It is believed that the disclosure will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings are necessarily to scale.

FIG. 1 is a perspective view of a system according to an embodiment of the present disclosure having a first and a second recirculation loop;

FIG. 2 is a perspective view of the system according to the embodiment of FIG. 1 rotated 180 degrees clockwise;

FIG. 4 is an enlarged, perspective view of the system according to the embodiment of FIG. 1, with certain structures removed to better illustrate the second recirculation loop;

FIG. 5 is a perspective view of a screen or screening apparatus according to the embodiment of FIG. 1 as may be used as a primary or main screen;

FIG. 6 is a perspective view of a shredder according to the embodiment of FIG. 1;

FIG. 7 is a perspective view of a screen or screening apparatus according to the embodiment of FIG. 1 as may be used as a secondary screen;

FIG. 8 is a perspective view of a separator including at least one air separation device;

FIG. 9 is a cross-sectional view of the separator of FIG. 8, illustrating the at least one air separation device;

FIG. 10 is a perspective view of an optical separation station and associated conveyors, the conveyors also being associated with one or more holding bunkers and one or more discharge bunkers;

FIG. 11 is a schematic view of the optical separation station;

FIG. 12 is a first schematic illustrating a method of operating the embodiment of FIGS. 1-11;

FIG. 13 is a second schematic illustrating a method of operating the embodiment of FIGS. 1-11;

FIG. 14 is a schematic of a first optional embodiment of operating the embodiment of FIGS. 1-11 according to FIG. 13; and

FIG. 15 is a schematic of a second optional embodiment of operating the embodiment of FIGS. 1-11 according to FIG. 13.

### DETAILED DESCRIPTION OF VARIOUS EMBODIMENTS

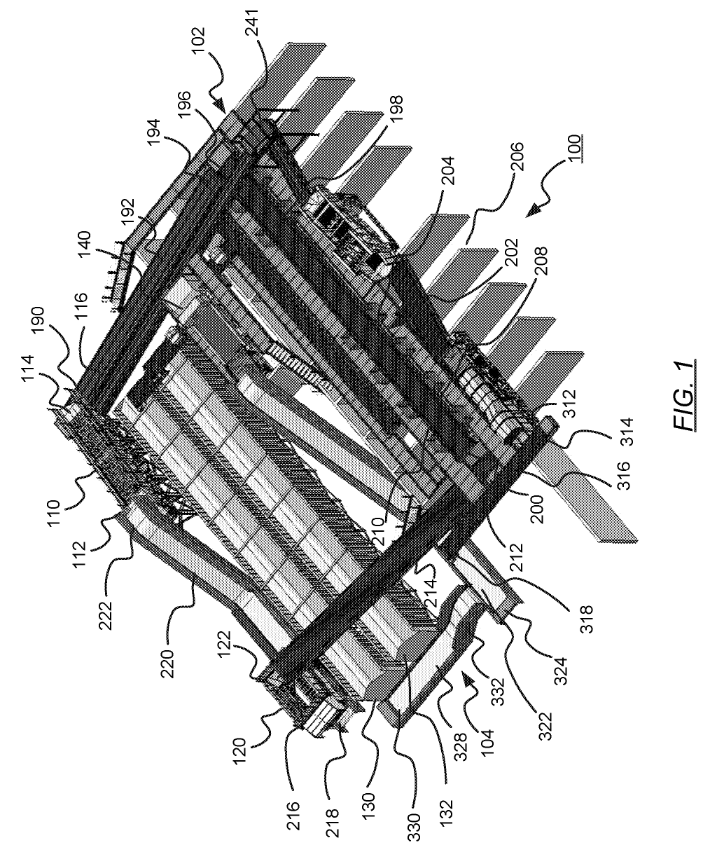

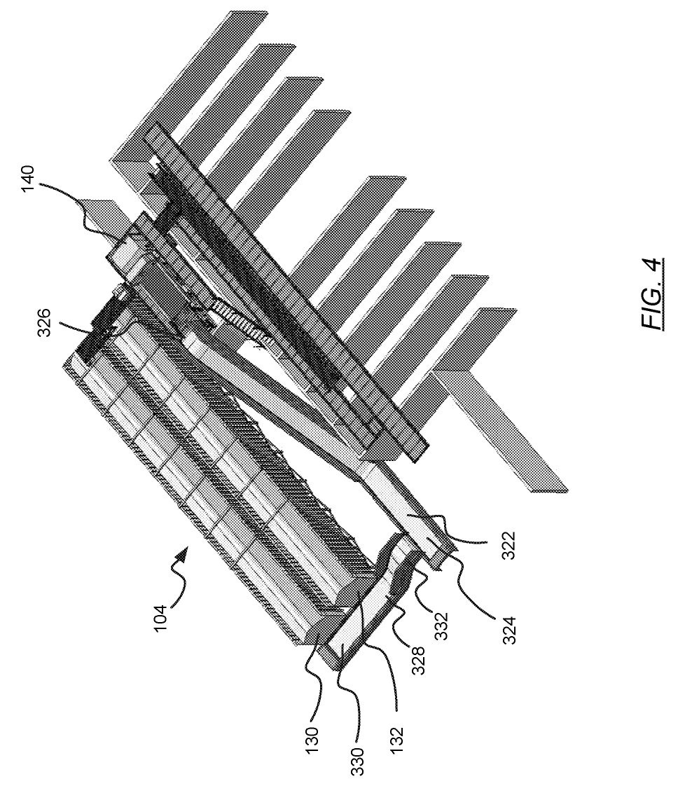

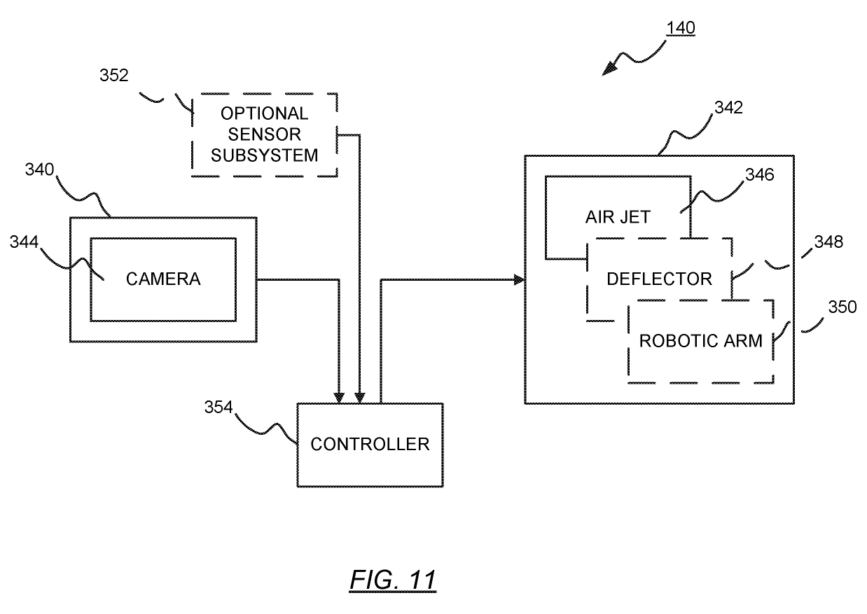

A system 100 for separating a mixture of materials is illustrated in the drawings. The system 100 may be a recycling system (or part of a recycling system), and the mixture of materials may be, but is not limited to, construction and demolition (C&D) materials. FIGS. 1-4 illustrate an embodiment of the system 100 more generally, while FIGS. 5-11 illustrate equipment incorporated into the embodiment of FIG. 1-4. Finally, FIGS. 12-15 illustrate embodiments and variants of embodiments of operating the system 100.

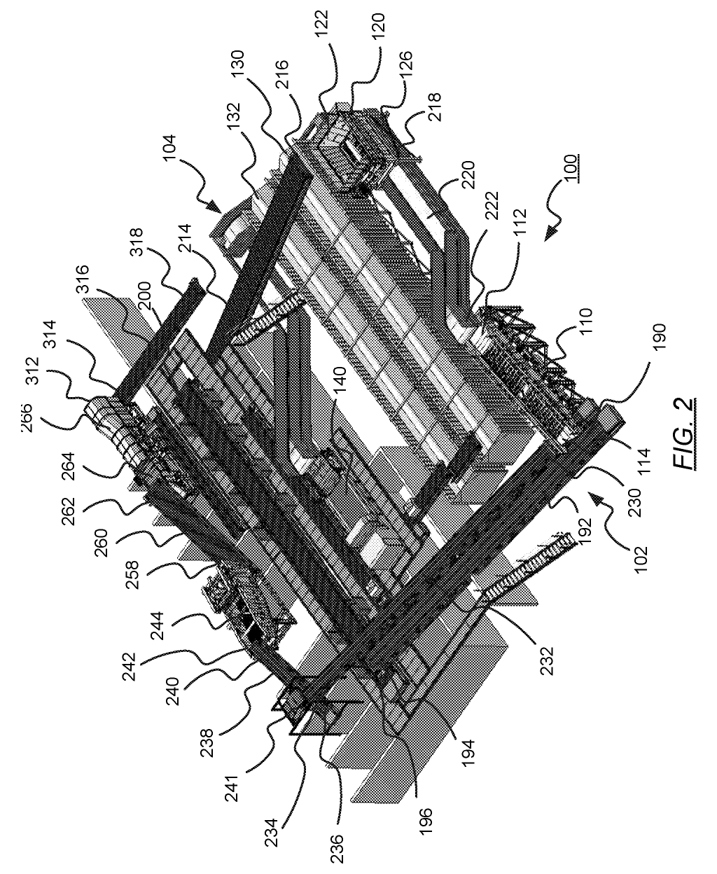

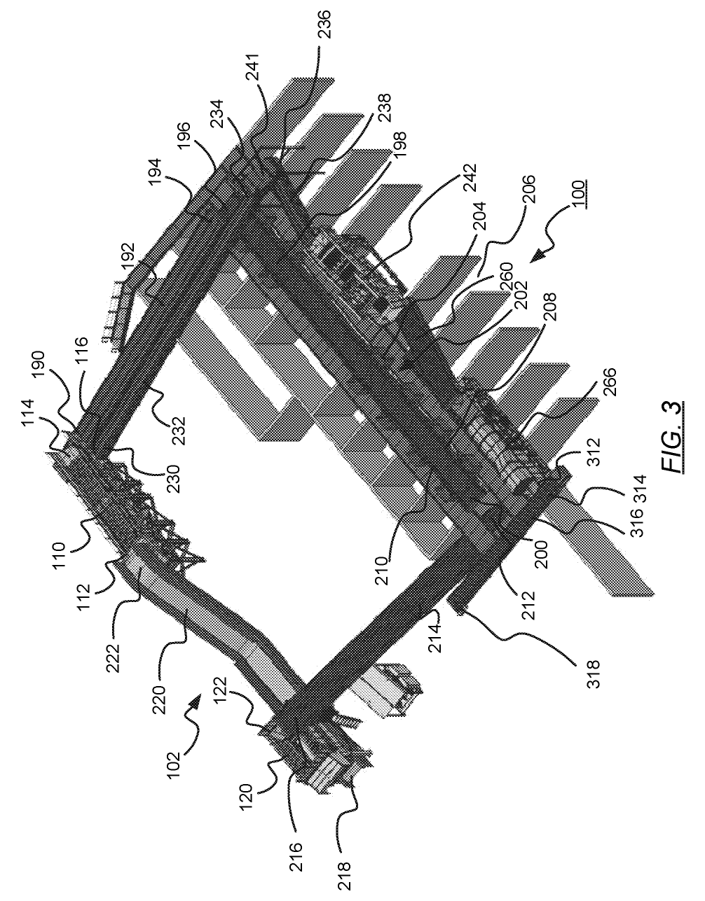

Starting with FIGS. 1 and 2, the system 100 includes at least two recirculation loops, a first recirculation loop 102 and a second recirculation loop 104. See also FIG. 3 as to the first loop 102 and FIG. 4 as to the second loop 104. As illustrated, the first recirculation loop 102 is generally disposed about the second recirculation loop 104. As such, the first recirculation loop 102 may also be referred to as the outer recirculation loop and the second recirculation loop 104 may also be referred to as the inner recirculation loop. The illustrated embodiment is not intended to limit the disclosure to only an embodiment wherein the first loop may be referred to as outer and the second loop may be referred to as inner; this convention is used simply for ease of explanation.

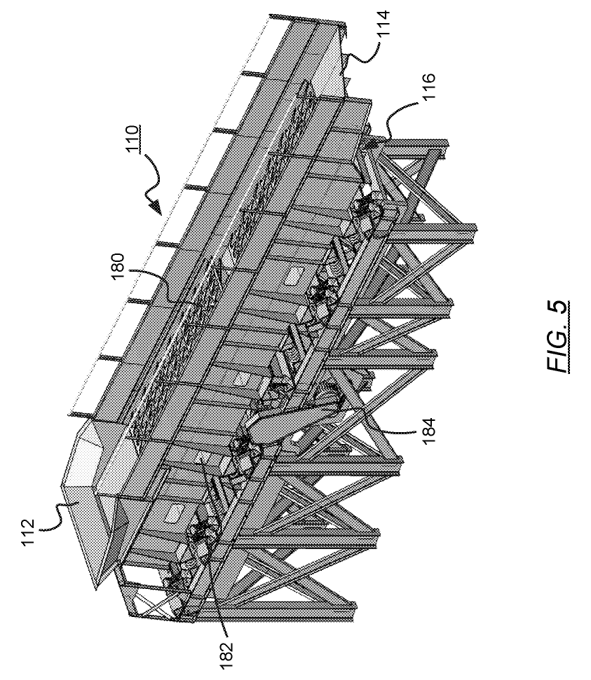

According to the illustrated embodiment, the first recirculation loop 102 includes at least one separation station 110. As illustrated and described in more detail relative to FIG. 5, the separation station 110 may be a screen or screen apparatus, specifically a vibratory screen or vibratory screen apparatus. The separation station having an inlet 112 configured to receive the mixture of materials and at least a first outlet 114 and a second outlet 116. The first outlet 114 is coupled (i.e., directly or indirectly connected; in the case of the illustrated embodiment, via several conveyors) to the inlet 112 via a shredder 120 (see also FIG. 6) and the second outlet 116 coupled to at least one holding bunker 130 (as illustrated, via conveyors and other equipment as discussed below).

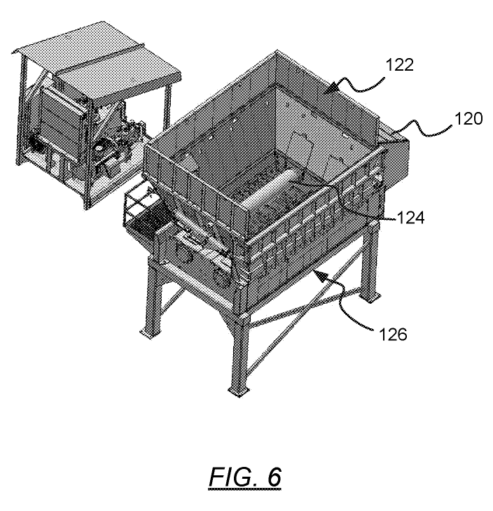

The first recirculation loop 102 may include other equipment in addition to the shredder 120. For example, the loop 102 may include one or more independent sorting stations, a magnetic separator, a secondary screen or screen apparatus, an air separator, and a plurality of conveyors to couple the separation station 110, shredder 120, and holding bunker(s) 130 to this equipment. Certain items of equipment, such as the secondary screen and the air separator, are illustrated in FIGS. 7-9.

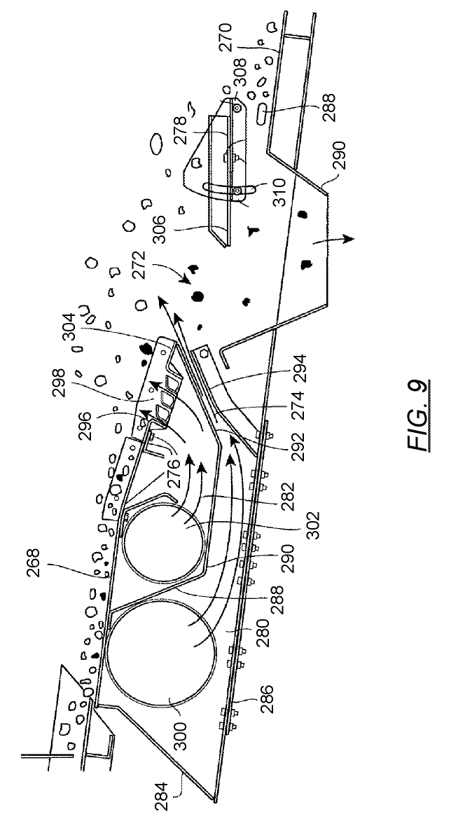

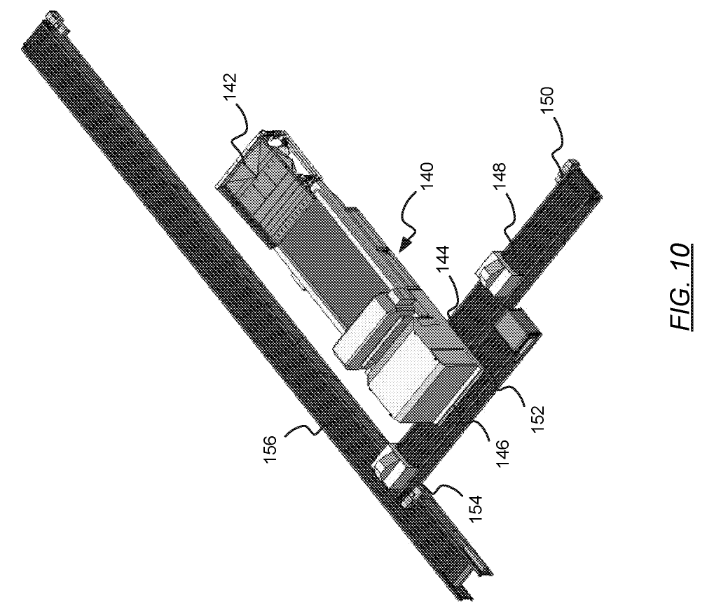

According to the illustrated embodiment, the second recirculation loop 104 also includes at least one separation station 140. As illustrated and described in more detail relative to FIGS. 10 and 11, the separation station 140 may be an optical sorter. The at least one separation station 140 may have an inlet 142 coupled to the at least one holding bunker 130 and at least a first outlet 144 and a second outlet 146. The first outlet 144 is coupled to the at least one holding bunker 130 and the second outlet 146 is coupled to at least one discharge bunker. See FIGS. 1-4 and FIG. 10.

As will also be explained below, the second recirculation loop 104 may include other equipment in addition to the separation station 140. For example, in a first instance, the second recirculation loop 104 may be configured to work with a first and a second holding bunker 130, 132. Alternatively, in a second instance, the second recirculation loop 104 may be configured to work with only a single holding bunker 130.

In the first instance, the inlet 142 of the at least one separation station 140 of the second recirculation loop 104 is coupled to the first holding bunker 130, and the first outlet 144 of the at least one separation station 140 of the second recirculation loop 104 is coupled to the second holding bunker 132. The at least one separation station 140 the separates a first material from the mixture of materials until the holding bunker 130 is empty, for example. After emptying the first bunker 130, the inlet 142 may be coupled to the second bunker 132 and the outlet 144 may be coupled to the first bunker 130.

In the second instance, the inlet 142 of the at least one separation station 140 of the second recirculation loop 104 is coupled to the single holding bunker 130, and the first outlet 144 of the at least one separation station 140 of the second recirculation loop 104 is coupled to the single holding bunker 130. The at least one separation station 140 separates a first material from the mixture of materials as the single holding bunker is emptied until the first material has met a separation criterion or criteria. As one example, the criterion may be that the system operator wishes to separate out a second material. The at least one separation station 140 then separates the second material from the mixture of materials after the separation criteria has been met. In either event, the outlet 144 is coupled to the holding bunker 130.

The system 100 may be operated generally according to a method 160 for separating a mixture of materials as illustrated in FIG. 12. As one embodiment, the method 160 may include separating the mixture of materials into a first material stream (e.g., exiting the separation station 110 at outlet 114) and a second material stream (e.g., at outlet 116) at block 162. The method 160 may also include shredding (e.g., at shredder 120) at block 164 and returning the first material stream for further separation (e.g., at inlet 112) at block 162, and directing the second material stream to at least one holding bunker 130, 132 at block 166. Additionally, the method 160 may include separating materials from the at least one holding bunker 130, 132 into a third material stream (e.g., exiting the separation station 140 at outlet 144) and a fourth material stream (e.g., at outlet 146) at block 168. In addition, the method 160 may include returning the third material stream to the at least one holding bunker 130, 132 and/or directing the fourth material stream to at least one discharge bunker at block 170.

It will be recognized that the method 160 for separating using the system 100 may vary according to the equipment incorporated into the first and second loops. For example, different steps may be performed if there are two holding bunkers 130, 132 or only a single holding bunker 130. Similarly, the presence of additional separators, such as the secondary screen, the air separator, and magnetic separator will vary the specifics of the method. Some variants will be discussed below, although it would be difficult to describe all of the possible variants of the base system 100 and base method 160. As such, the discussion below is for purposes of illustration, and not limitation, of the system 100 and method 160 disclosed herein.

Having discussed the system 100 and method 160 in general terms, the system 100 and its operation are now described relative to the embodiment of FIGS. 1-11, starting with FIGS. 1 and 2 and the first (or outer) recirculation loop 102.

Starting at the upper corner of FIG. 1 or the lower corner of FIG. 2, material enters the system 100 at the inlet 112 of the separation station 110, which will be referred to as the primary screen 110 with reference to the embodiment illustrated in FIGS. 1 and 2 (and 5). Thus, the primary screen 110 will also be referred to as having an inlet 112 configured to receive the mixture of materials. It will be recognized, however, that in a more general sense the separation station 110 may include equipment other than or in place of the primary vibratory screen apparatus illustrated in FIGS. 1 and 2, and so reference to the primary screen 110 is for ease of explanation relative to the illustrated embodiment and not by way of limitation relative to the invention claimed.

Turning for the moment to FIG. 5, the primary screen 110 has a first, or upper, deck 180 and a second, or lower, deck 182. The upper deck 180 may include openings, apertures, holes, passages, or the like, and may be referred to as perforated or foraminous in certain embodiments. In the illustrated embodiment, the passages are formed by cantilevered structures referred to as fingers, so that the screen 110 may be referred to as a finger screen. Materials smaller than a given size may pass from the upper deck 180 to the lower deck 182 and exit the structure via the second outlet 116. Materials larger than a given may pass over and along the upper deck 180 and be directed to the first outlet 114.

As mentioned above, the primary screen 110 is a vibratory apparatus, and thus has a vibratory drive 184 attached thereto. The drive 184 may include a shaft to which one or more eccentric masses are attached. According to certain embodiments, the drive includes one or more motors, and the motor shaft(s) have the eccentric masses attached thereto. The drive 184 may be designed to operate in a brute-force fashion, or as part of a two-mass system as illustrated.

Returning to FIGS. 1 and 2, the material that has passed over the upper deck 180 and exits via the first outlet 114 is directed to a first end 190 of a conveyor 192. The material is carried along the conveyor 192 to the second end 194, where the material is directed to a first end 196 of a conveyor 198 (see FIG. 1). The conveyor 198 is at a right angle to the conveyor 192 and carries the material to a second end 200. The conveyors 192, 198 may be belt conveyors as illustrated, although other types of conveyors may be used instead.

As the material passes along the conveyor 198 to the second end 200, the material moves past one or more sorting stations 202. See FIG. 1. As such, the first outlet 114 of the primary screen 110 may be described as coupled to the one or more storing stations. Likewise, the outlet 114 of the primary screen may be described as coupled via the one or more sorting stations 202 to the shredder 120 by virtue of the conveyors described below.

As illustrated in FIG. 1 (and FIG. 2), there are a plurality of sorting stations 202. As illustrated, each sorting station 202 is intended to be a manual sorting station 202 with a worker assigned to a one or more chutes 204. The worker removes particular items from the conveyor 198 and deposits the items into the chutes 204 to be deposited in one of a plurality of discharge bunkers 206.

The stations 202 may be arranged to either side 208, 210 of the conveyor 198, although that is not required according to all embodiments. Whether to dispose the stations 202 on either one side 208, 210 or both sides 208, 210 (as illustrated) of the conveyor 198 may depend on the width of the conveyor 198 relative to the worker’s reach, of if other equipment is used instead of a human worker that may have a greater reach (see below). The decision as to the location of stations 202 may also depend on the number of stations required, or the number of times the material is likely to be passed along the conveyor 198.

While the stations 202 are manual sorting stations as illustrated, the sorting stations are not limited to being manual sorting stations. Indeed, a robotic picker or picking machine could be assigned to some or all of the stations 202 instead of a human worker. These robotic pickers could use machine vision to identify items moving along the conveyor 198. According to such an embodiment, the robotic picker (or picker arm) would lift items from the conveyor 198 and place the items in the chutes 204.

The end 200 of the conveyor 198 is aligned with a first end 212 of a conveyor 214. The conveyor 214 is at a right angle to the conveyor 198. The conveyor 214 may be a belt conveyor, like the conveyors 192, 198. The second end 216 of the conveyor 214 may be aligned with an inlet (or hopper) 122 of the shredder 120. See also FIG. 6.

The shredder 120 has one or more (typically a plurality of) shredding elements 124 disposed between the upper inlet 122 and a bottom outlet 126 of the shredder 120. The shredding elements 124 may rotate about an axis, and each shredding element 124 may have a radially outward edge that cooperates with the radially outward edge of another of the shredding elements 124. The cooperation of the shredding elements 124 may shred materials deposited in the upper inlet or hopper 122 as they pass or are driven through the shredder 120 between the inlet 122 and the outlet 126.

Shredded material passing through the outlet 126 is deposited at a first end 218 of a conveyor 220, as best seen in FIG. 2. The conveyor 220

transports the material from the end 218 to a second end 222. The second end 222 of the conveyor 220 is aligned with the inlet 112 of the separation station 110. Material exiting the second end 222 enters the inlet 112, completing this path around the first recirculation loop 102.

In the alternative to this path, the material that has passed through the deck 180 is deposited on the lower deck 182. See FIG. 5. This material is moved along the deck 182, exits via the second outlet 116, and is directed to a first end 230 of a conveyor 232. See FIG. 2. The material is carried along the conveyor 232 to the second end 234, where the material is directed to a first end 236 of a conveyor 238. The conveyor 238 is at a right angle to the conveyor 232 and carries the material to a second end 240. The conveyors 232, 238 may be belt conveyors as illustrated, although other types of conveyors may be used instead.

As seen in FIG. 2, a magnetic separator 241 also is disposed at the end 234 of the conveyor 232. The magnetic separator 241 uses a magnetic field to remove items from the material passing between conveyors 232, 238. The separator 241 may deposit the removed items in a discharge bunker 206.

As for the material passing from the end 234 of conveyor 232 to the end 236 of conveyor 238, that material moves to the second end 240 and into the inlet 242 of a secondary screen 244. See FIG. 7. As such, the secondary screen 244 may be described as coupled to the second outlet 116 of the primary screen 110 by the conveyors 232, 238. Moreover, the magnetic separator 241 may be described as coupled between the second outlet 116 of the primary screen 110 and the secondary screen 244.

As seen in FIG. 7, the screen 244 has a deck 246 with openings, apertures, holes, passages, and the like, and may be referred to as perforated or foraminous in certain embodiments. Materials larger than a given size may pass over and along the deck 246 and be directed to a first outlet 248. Materials smaller than a given size may pass through the deck 246 exit the structure via an open bottom outlet 250, for example into a discharge bunker 206.

Coupled to the deck 246 of the secondary screen 244 is an exciter 252. The exciter 252 includes a motor 254 having a shaft with eccentric masses attached thereto. The exciter 252 is coupled to the deck 246 via one or more pairs of links and resilient members (or springs) 256. The screen 244 is thus configured as a two-mass vibratory apparatus.

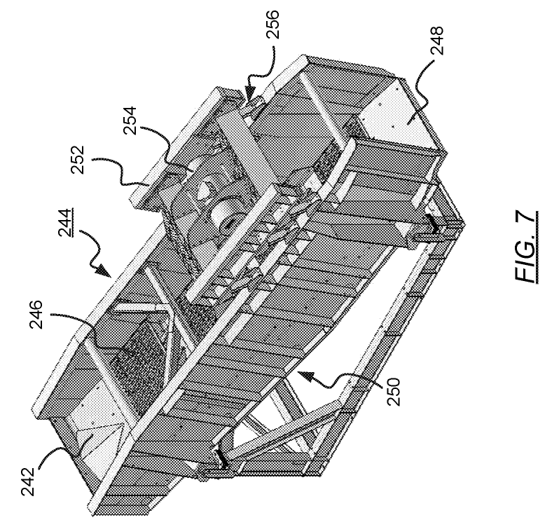

Returning to FIG. 2, a first end 258 of a conveyor 260 is disposed at the first outlet 248 (see FIG. 7) of the secondary screen 244. The conveyor 260, which may be a belt conveyor, moves the material to a second end 262. The second end 262 is disposed at an inlet 264 of an air separator or classifier 266. See also FIG. 8. Thus, the air separator 266 is coupled to the second outlet 116 by the conveyors 232, 238, 260 and via the secondary screen 244.

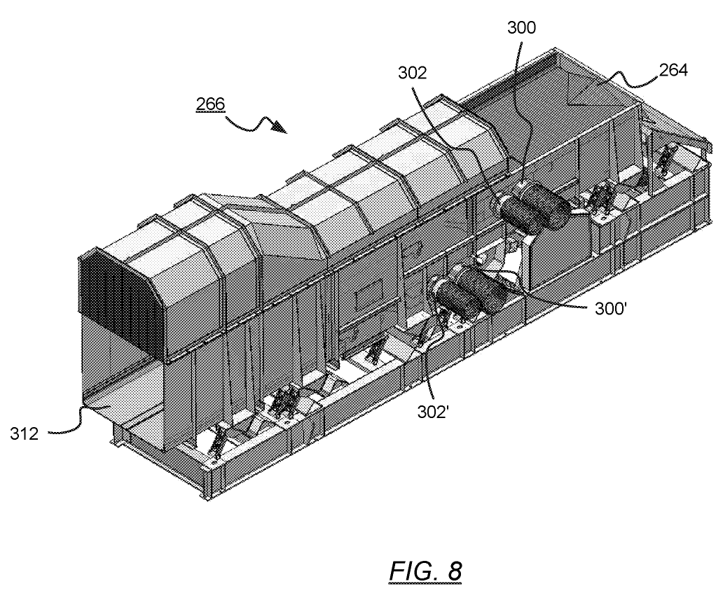

The air separator or classifier 266 uses one or more streams of air to separate materials passing through the classifier 266. To this end, the separator 266 includes a conveying surface divided into at least two spaced deck sections, each of which may be defined by one or more deck plates. As illustrated in FIG. 9, the conveying surface includes a first deck section 268 and a second deck section 270. A drop out or drop out opening 272 is disposed between the first and second deck sections 268, 270, the drop out 272 defining at least one outlet, which outlet may permit materials to pass out of the separator 266 or from a first air separation module to a second air separation module, for example.

The separator 266 includes an air knife 274, which according to the illustrated embodiment is an adjustable air knife 274, to produce one of the one or more streams of air. The air knife 274 may be used to separate those materials passing along the first deck section 268 into those materials passing over the drop out 272 to the second deck section 270 and those materials passing through the drop out 272. In particular, the air knife 274 directs the air upward into the drop out 272. This causes air to impinge upon particles passing from the first deck section 268. The action of the air upon the particles separates heavier and lighter particles, the heavier particles (or fraction) passing through the drop out 272 and the lighter particles (or fraction) passing over the drop out 272. Any particles that may be blown “back” toward the inlet 264 may be confined by disposing a flap upstream of the first section 268.

The separator 266 may also include an optional adjustable fluidizer deck 276 and an optional adjustable landing plate 278 that may be used in conjunction with the air knife 274. Fluidizing air passing through the fluidizer deck 276 works the material bed passing over the first deck section 268, and allows the heavier fraction to collect at the bottom or lower level of the bed. It is believed that this allows the heavier particles to fall down through the air stream formed by the air knife 274 more easily by reducing the number of lighter particles hitting or impacting on heavies causing incomplete separation. The exact nature of the separation may be further refined by adjusting the length and/or angle of the associated adjustable landing plate 278, which functions as an extension of the second deck section 270.

In conjunction with the air knife 274 and the fluidizer deck 276, the separator 266 includes a pair of pressurized chambers 280, 282. The first and second pressure chambers 280, 282 are each connected to one of the adjustable air knife 274 and the adjustable fluidizer deck 276.

The first pressure chamber 280 is defined, at least in part, by the first deck section 268, walls 284, 286, 288, 290, an air knife baffle 292 and an adjustable deflector plate 294. The adjustable deflector plate 294 extends angularly upwardly from the bottom wall 286 and runs generally parallel to the air knife baffle 292. Together, the baffle 292 and the adjustable deflector plate 294 form the adjustable air knife 274.

The deflector plate 294 may be adjusted toward or away from the baffle 292, by being translated or shifted along the surface of the wall 286, such that the width of the air knife 274 is either narrowed or enlarged. For example, the deflector plate 294 may be mounted to the wall 286 by nut-bolt pairs disposed through at least one transverse slot formed in the wall 286, whereby, for purposes of adjustment, the deflector plate 294 may be shifted to alter the width of the air knife 274.

By adjusting the deflector plate 294 towards the baffle 292, the air stream, or column of air passing from the pressurized chamber 280 to the drop out opening 272, will have a higher velocity, narrower width profile. This profile may be well suited for separating two or more commingled, relatively light objects, such as paper and glass. Alternatively, by adjusting the deflector plate 294 away from the baffle 292, the air stream will have a lower velocity, wider width profile. The lower velocity, wider width profile may be well suited for separating other, heavier commingled objects, such as wood and rock, for example.

It will be recognized that graduated adjustments to the deflector 294 may be made to choose a desired line of separation between the heavier particles or fraction and the lighter particles or fraction. By adjusting the widths of the air column, the separator 266 may be configured to separate a variety of composite mixtures. In this way, a single separator 266 may separate a number of materials in a multi-material waste stream.

The second pressure chamber 282 is defined, at least in part, by the first deck section 268, the fluidizer deck 276, walls 288, 290, and the air knife baffle 292. The fluidizer deck 276 has a surface 296 with openings 298, which may be louvered openings. The openings 298 in the surface 296 may be aimed in any desired direction, including, for example, a generally perpendicular direction to the surface 296. The openings 298 are of a size determined according to the material being fluidized. For example, bark chunks typically require more fluidizing air and therefore may need larger openings 298, while saw dust typically needs less fluidizing air and therefore may need smaller openings 298.

The vibratory motion of the separator 266 causes the composite material, which is composed of materials of various densities, to move over the fluidizer deck 276 wherein the material is fluidized as it passes over the openings 298. Air from the pressure chamber 282 blows up through the openings 298 to initially tumble and agitate the large bound together clumps. The fluidizing air works the various sized parts of the disintegrating clumps to form a bed of the parts of the composite material, allowing the heavier fraction to collect at the bottom or lower level of the bed. This causes some of the lighter loose particles to bob and jump above the upper level of the bed. The air from the pressure chamber 282 adds to the vibratory motion to increase the agitation and tumbling of the composite material for abrading one clump against another and at the same time the pressurized air emitting from the openings 298 will tear, shred, and rip the clumped and matted mass apart.

The chambers 280, 282 are supplied with air by a remote blower. The remote blower communicates through a pair of flexible conduits, each of which is connected to one of the pressure chambers 280, 282 via an air intake 300, 302. See FIG. 9, and also FIG. 8. The amount of air entering the chambers 280, 282 may be controlled via a gate, for example disposed at the air intake 300, 302. The mechanisms used to connect to the air intakes 300, 302 and control the amount of air entering the chambers 280, 282 may vary, such that the illustrated embodiment is for purposes of explanation and not limitation.

As mentioned above, the optional, adjustable landing plate 278 may be included to permit further graduated adjustments to the size of the drop out opening 272 (i.e., between 304, 306) and the angle of the landing surface. For example, in the illustrated embodiment, the landing plate 278 includes flanges 308 on each end of the plate. An extension may be attached to the flanges 308, and may be translatable to vary, at least in part, the distance between 304, 306. Further, a pivot is connected at a first end of the flanges 308 and a rod is connected to a second end of the flanges 308, The rod passes through and along an arcuate opening 310 in the side walls of the separator 266, and may be secured in place (e.g., by bolts received on threaded ends of the rod) to vary the angle of the landing surface.

As mentioned above, the separator 266 may include more than one air knife with optional fluidizer deck and landing plate, which has also been referred to herein as an air separation module. To this end, it will be recognized that in FIG. 8 additional take intakes 300’, 302’ have been provided, which intakes 300’, 302’ would be part of a structure or module similar to that illustrated in FIG. 9, although as mentioned previously the fluidizer deck and landing plate would be optional. In this manner, the separator 266 may separate a first, lighter material from a second and third material at the first module or instance of the structure of FIG. 9 (indicated by intakes 300, 302), and the second, lighter material from the third material at the second module or instance of the structure of FIG. 9 (indicated by intakes 300’, 302’). It may even be possible to combine the first and second materials downstream of the second instance of the structure of FIG. 9.

Returning to FIG. 2, at the outlet 312 of the air separator 266 (see also FIG. 8) is disposed adjacent to a first end 314 of a conveyor 316. The conveyor 316 is at a right angle to a longitudinal axis of the air separator 266. The conveyor 316 may be a belt conveyor as shown. The belt conveyor 316 may transport materials to a second end 318, which end 318 is disposed above the conveyor 322 (see FIGS. 1 and 4). Likewise, the conveyor 322 extends from a first end 324 to a second end 326. The second end 326 is disposed at the inlet 142 of the separation station 140. Compare FIGS. 4 and 10. Material passing from the second end 326 into the inlet 142 is either sorted by the separation station 140 to a first outlet 144 to a holding bunker 130, 132 or to a second outlet 146 to a discharge bunker. As a further alternative, the material may simply pass through the station 140 to the holding bunker 130, 132 without being sorted.

Consequently, it may be stated that the second outlet of the main screen 110 is coupled via the secondary screen 244 and the air separator 266 (by the conveyors 232, 238, 260, 316, 322) to the holding bunker(s) 130, 132. It may also be stated that the air separator 266 has an outlet 312 that is coupled to the at least one holding bunker 130, 132 via the separation station 140 of the second recirculation loop 104.

The first circulation loop 102 may be operated to fill one of the bunkers 130, 132 or the single bunker 130, for example during a daytime shift. Once the bunker(s) 130, 132 is full, the second circulation loop 104 may be operated to separate the material in the bunker 130, 132, for example during a nighttime shift.

As noted above, the second circulation loop 102 includes the separation station 140 and the conveyor 322 that leads to the inlet 142 of the separation station 140. The second circulation loop 102 also includes a conveyor 328 upstream of the conveyor 322, which conveyor 328 connects the holding bunker(s) 130, 132 to the conveyor 322. To this end, the conveyor 328 has a first end 330 disposed such that either bunker 130, 132 or the bunker 130 may deliver material to the conveyor 328. The conveyor 328 then moves the material along the conveyor 328 to a second end 332, where it falls on to the first end 324 of the conveyor 322.

As is seen in part in FIGS. 1, 2, and 4 and in full in FIG. 10, the separation station 140 has a plurality of conveyors associated with the station 140. As discussed above, the at least one separation station 140 has an inlet 142 coupled to the at least one holding bunker 130 and at least a first outlet 144 and a second outlet 146. The material exiting the first outlet 144 is disposed on a conveyor 148 and carried to an end 150, from which it will be directed to bunker 130, 132 according to the structure of the specific embodiment of the system 100 and the operation of the method 160. The material exiting the second outlet 146 is disposed on a conveyor 152 and carried to an end 154. The material passes from the end 154 to a further conveyor 156 that transports the material to one of a plurality of discharge bunkers 206.

The separation station 140 may be an optical sorting station, an embodiment of which is illustrated schematically in FIG. 11. The optical separation, or sorting, station may include an optical subsystem 340 and a selector or sorter 342. The optical subsystem 340 may include a device, such as a camera 344, to obtain data about material(s) moving through the station, using machine vision, for example. The selector or sorter may include a machine, such as an air jet 346, a mechanical deflector 348, or a robotic arm 350, that moves (e.g., pushes or carries) materials between different outlet options. The optical sorting station may include other equipment as well, such as optional sensor subsystems 352 that may provide data concerning temperature or humidity, for example. In addition, the separation station includes a mechanism for moving the material through the station, such as a belt conveyor.

A controller 354 may be coupled (e.g., connected directly or indirectly (i.e., with intervening components or equipment) hardwired or wirelessly) to the optical subsystem 340 (and optional sensor subsystem 352) and the selector or sorter 342. The controller 354 may use the information obtained from the optical subsystem 340 (and other optional sensor subsystem 352) to cause the selector or sorter 342 to move the materials to one of the outlet options automatically. For example, the controller 354 may include a processor and associated memory, and instructions may be stored on the memory that when performed on the processor cause the processor to control the selector or sorter 342 to move the materials between different outlet options.

In regard to the controller 354, it will be recognized that the processor may be a microprocessor (which, in fact, may include multiple physical and/or virtual processors). According to other embodiments, the controller may include one or more electrical circuits designed to carry out the actions described herein. In fact, the controller may include a microprocessor and other circuits or circuitry. In addition, the controller may include one or more memories, as mentioned above. The instructions by which the microprocessor is programmed may be stored on the one or more memories associated with the microprocessor, which memory/memories may include one or more tangible non-transitory computer readable memories, having computer executable instructions stored thereon, which when executed by the microprocessor, may cause the microprocessor to carry out one or more actions as described herein.

As to the nature of the instructions, these may be in the form of one or more programs, routines, modules, etc. that specify the conditions under which a material is moved toward one of the output options. As an alternative or in combination with such programs, the controller 354 may be programmed to use artificial intelligence, such as machine learning or deep learning, to make the selections necessary to move the materials to one of the outlet options according to the embodiments of the method 160 discussed herein. All such options are possible according to embodiments of the present disclosure.

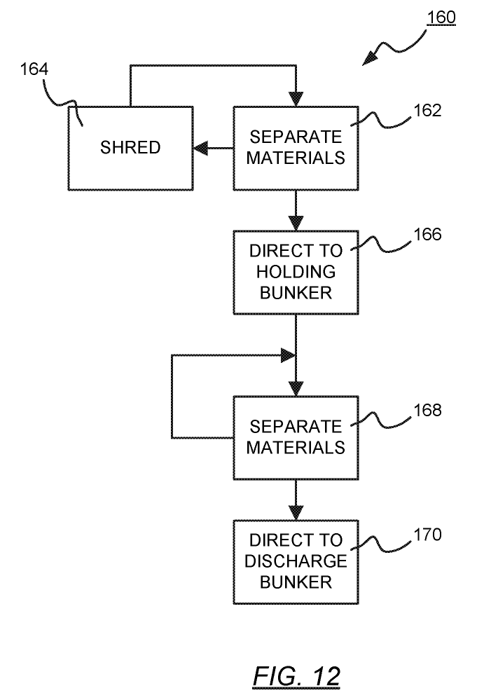

As noted above, the system 100 may be operated according to the method illustrated in FIG. 12. This may include separating the mixture of materials into a first material stream (e.g., exiting the separation station 110 at outlet 114) and a second material stream (e.g., at outlet 116) at block 162. The method may also include shredding (e.g., at shredder 120) at block 164 and returning the first material stream for further separation (e.g., at inlet 112) at block 162, and directing the second material stream to at least one holding bunker 130, 132 at block 166. The method may further include separating materials from the at least one holding bunker 130, 132 into a third material stream (e.g., exiting the separation station 140 at outlet 144) and a fourth material stream (e.g., at outlet 146) at block 168. In addition, the method may include returning the third material stream to the at least one holding bunker 130, 132 and directing the fourth material stream to at least one discharge bunker 206 at block 170. A more detailed method 360 may now be discussed with reference to FIGS. 13-15.

The method 360 begins at a block 362 with the screening of a mixed material supply, such as may be provided as a consequence of construction and/or demolition activity. The screening at block 362 may be referred to as the primary screening step, and may be performed using the screen 110. This screening step may generate two streams of materials.

The method 360 may continue with one of the streams of materials at block 364, where a sort is performed on the materials in this stream of materials. As illustrated, this sort may be a manual sort, and may be performed by the one or more workers assigned to the sorting stations 202. Removed materials may be deposited via the chutes 204 into one or more of the discharge bunkers 206.

The method 360 may continue at block 366, where the materials that remain on the conveyor 198 after the manual sort at the stations 202 are shredded. This action may be performed by the shredder 120, before the shredded material is returned to the screen 110 and the method 360 returns to block 362.

In the alternative to the actions at blocks 364, 366, the method 360 may continue at block 368 with a magnetic separation. This may be performed using the magnetic separator 241. Any ferrous materials may be removed from the stream of materials, and discharged into a discharge bunker 206. The remaining material may be passed to a secondary screen 244 as the method 360 continues at block 370.

Once the screening has been performed at block 370, the method 360 continues at block 372. This stream of materials enters the air separator or classifier 266, and one or more air separations are performed of the mixed materials. As noted above, the separator 266 may include multiple (e.g., two) air knives, along with associated optional adjustable fluidizer decks and adjustable landing plates, for performing multiple (e.g., at least two) separations. As such, while this block refers to separation with air, this does not limit the action taken here to a single separation (in the same way that other actions at other blocks are not limited to a single separation, shredding, or sorting).

The method 360 continues with an optional optical sort at block 374 as the materials pass through the optical sorter station 140. It will be recognized that while an optical sort may be performed at block 374, it is possible that the station 140 and associated conveyor are simply used to move the materials to the one or more holding bunkers 130, 132 at block 376 without the sort.

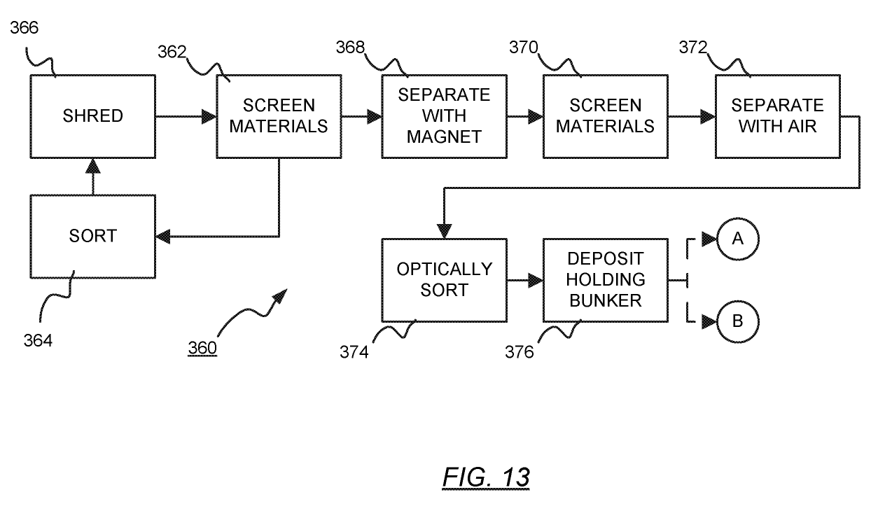

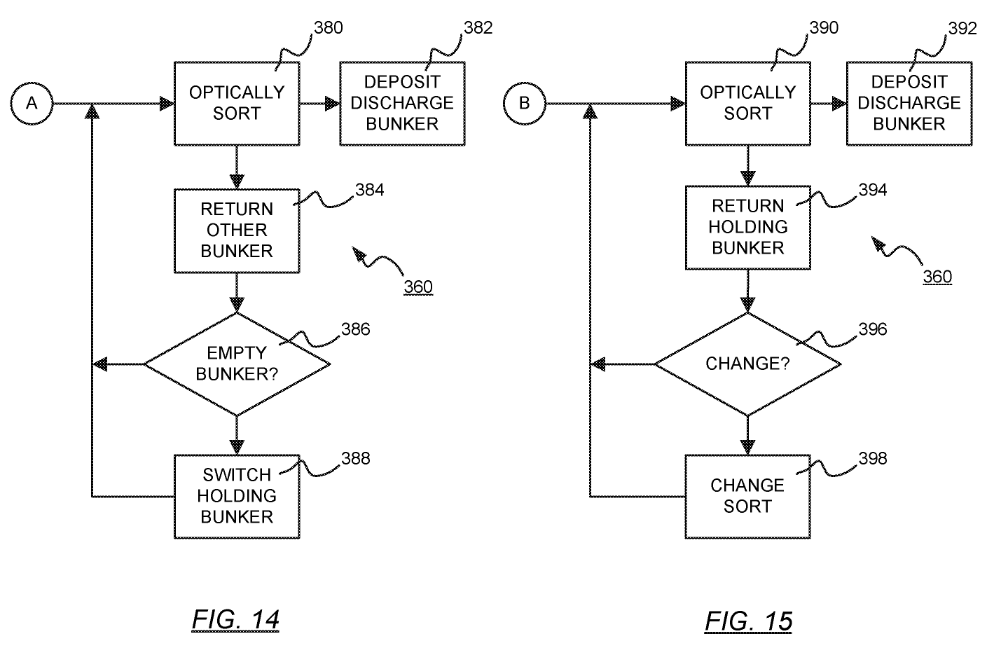

At this point, the method 360 may continue with the further actions of FIG. 14 (“A”) or the further actions of FIG. 15 (“B”) depending on whether the system 100 utilizes both bunkers (130, 132) in an alternating fashion or a single bunker (e.g., 130).

Assuming that the system 100 utilizes both bunkers 130, 132, the method 360 continues to block 380 of FIG. 14. At block 380, the optical sorting station 140 is used to perform an optical sort of the materials received from the bunker (e.g., 130) that has been filled during a first shift by the operation of the first loop 102. The station may separate a first material that is deposited in a discharge bunker 206 as the method 360 continues to block 382, with other material(s) being returned to the other bunker (e.g., 132) at block 384.

At this point, the method 360 may continue with a determination whether the bunker 130 is empty at block 386. The controller 354 of the sorting station 140 may be programmed to perform this determination, for example. If the bunker 130 is empty, the sorting station 140 may be switched, at block 388, to receive materials from the bunker 132 and to sort for a different material than the first material. If not, the method 360 may return to block 380.

Assuming that the system 100 utilizes only one bunker 130, the method 360 continues to block 390 of FIG. 15. At block 390, the optical sorting station 140 is used to perform an optical sort of the materials received from the bunker 130 that has been filled during a first shift by the operation of the first loop 102. The station may separate a first material that is deposited in a discharge bunker 206 as the method 360 continues to block 392, with other material(s) being returned to the bunker 130 at block 394.

At this point, the method 360 may continue with a determination at block 396 whether to change to sort for a different material than the first material at block 390. The controller 354 of the sorting station 140 may be programmed to perform this determination, for example. If it is determined that the sorting is to be performed to separate a material other than the first material, the sorting station 140 may be switched, at block 398. Otherwise, the method 360 may return to block 390.

The determination at block 396 may occur as a consequence of an instruction received from the system operator that a different material is to be separated from the mixed materials in bunker 130. This instruction may occur as a consequence of a change in the value of the first material relative to other materials that might be separated from the mixed materials in the bunker 130. Alternatively or in addition, the controller 354 may be programmed to determine that the sorting should be changed to another material when the amount of first material remaining in the mixed material stream entering the sorter station 140 is below a given threshold, or that an artificial intelligence determines that it is no longer desirable to sort for the first material.

Although the preceding text sets forth a detailed description of different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean...” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112(f).

What is claimed is:

1. A system for separating a mixture of materials, the system comprising:
a first recirculation loop including at least one separation station, the at least one separation station having an inlet configured to receive the mixture of materials and at least a first and a second outlet, the first outlet coupled to the inlet via a shredder and the second outlet coupled to at least one holding bunker; and
a second recirculation loop including at least one separation station, the at least one separation station having an inlet coupled to the at least one holding bunker and at least a first and a second outlet, the first outlet coupled to the at least one holding bunker and the second outlet coupled to a discharge bunker.

2. The system according to claim 1, wherein:
the at least one holding bunker comprises a first and a second holding bunker,
the inlet of the at least one separation station of the second recirculation loop is coupled to the first holding bunker, and the first outlet of the at least one separation station of the second recirculation loop is coupled to the second holding bunker.

3. The system according to claim 2, wherein the at least one separation station of the second recirculation loop is configured to separate a first material from the mixture of materials until the first holding bunker is empty.

4. The system according to claim 1, wherein:
the at least one holding bunker comprises a single holding bunker,
the inlet of the at least one separation station of the second recirculation loop is coupled to the single holding bunker, and the first outlet of the at least one separation station of the second recirculation loop is coupled to the single holding bunker.

5. The system according to claim 4, wherein the at least one separation station of the second recirculation loop is configured to separate a first material from a mixture of materials as the first holding bunker is emptied until the first material has met a separation criterion or criteria.

6. The system according to claim 5, wherein the at least one separation station of the second recirculation loop is configured to separate a second material from the mixture of materials after the first material has met the separation criterion or criteria.

7. The system according to claim 1, wherein the at least one separation station of the second recirculation loop is an optical sorter.

8. The system according to claim 1, wherein the at least one separation station of the first recirculation loop is a primary screen apparatus having an inlet configured to receive the mixture of the materials, a first outlet coupled via one or more independent sorting stations to the shredder, and a second outlet coupled via a secondary screen apparatus and an air separator to the at least one holding bunker.

9. The system according to claim 8, further comprising at least one magnetic separator coupled between the second outlet of the primary screen apparatus and the secondary screen apparatus.

10. The system according to claim 8, wherein the air separator has an outlet that is coupled to the at least one holding bunker via the separation station of the second recirculation loop.

11. A method for separating a mixture of materials, the method comprising:
separating the mixture of materials into a first material stream and a second material stream,
shredding and returning the first material stream for further separation,
directing the second material stream to at least one holding bunker,
separating materials from the at least one holding bunker into a third material stream and a fourth material stream,
returning the third material stream to the at least one holding bunker, and
directing the fourth material stream to at least one discharge bunker.

12. The method according to claim 11, wherein the at least one holding bunker comprises a first and a second holding bunker, and
separating materials from the at least one holding bunker comprises separating materials from the first holding bunker, and
returning the third material stream to the at least one holding bunker comprises returning the third material stream to the second holding bunker.

13. The method according to claim 12, wherein returning the third material stream to the second holding bunker continues until the first holding bunker is empty.

14. The method according to claim 11, wherein the at least one holding bunker comprises a single holding bunker, and
separating materials from the at least one holding bunker comprises separating materials from the single holding bunker, and
returning the third material stream to the at least one holding bunker comprises returning the third material stream to the single holding bunker.

15. The method according to claim 14, wherein the fourth material stream is directed to the at least one discharge bunker until a separation criterion or criteria has been met, after which the fourth material stream is directed to another discharge bunker.

16. The method according to claim 11, wherein separating materials from the at least one holding bunker comprises optically sorting the materials from the at least one holding bunker.

17. The method according to claim 11, wherein separating the mixture of materials into the first material stream and the second material stream comprises screening the mixture of materials into the first material stream and the second material stream.

18. The method according to claim 11, wherein shredding and returning the first material stream for further separation comprises returning the first material stream via one of more independent sorting stations.

19. The method according to claim 11, wherein directing the second material stream to the at least one bunker comprises directing the second material stream to the at least one bunker via at least one magnetic separator, at least one screening apparatus, and at least one air separator.

20. The method according to claim 19, wherein directing the second material stream to the at least one bunker comprises directing the second material stream to the at least one bunker via an optical sorter.
